(19) United States
(12) Patent Application Publication
(10) Pub. No.: US 2008/0244954 A1
(43) Pub. Date: Oct. 9, 2008

(54) Hunter's Scent Dispersing Apparatus

(76) Inventor: Samuel Shannon, Hardin, TX (US)

Correspondence Address: QUICKPATENTS, INC., 32861 CALLE PERFECTO, SUITE A, SAN JUAN CAPISTRANO, CA, 92675, US

(21) Appl. No.: 11/696,068

(22) Filed: Apr. 3, 2007

(51) Int. Cl. A01M 31/00; B01F 3/02

(52) U.S. Cl. 43/1

(57) ABSTRACT

An apparatus for dispersing a scent from a scent container, such as is typically used for hunting, is disclosed. The housing of the apparatus has at least one air inlet aperture and at least one air outlet aperture. A container attachment means is adapted for holding the scent container on a front wall of the housing. A fan is fixed within the housing and electrically connected to a battery and a switch. When the fan is electrically connected to the battery through the switch, the fan draws air from the air inlet aperture through the housing and out through the air outlet aperture, the fan blowing air across an opening of the scent container to mix air with the scent and to blow the mixture away from the housing. The apparatus includes a wrist strap to hand carry or suspend the apparatus from an object, and an arm attachment means.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to hunting, and more particularly to a scent dispersing apparatus.

### DISCUSSION OF RELATED ART

Scent dispersers for attracting deer and other animals are well known in the art. For example, U.S. Pat. No. 6,443,434 to Prather on Sep. 3, 2002 teaches such a device. Such devices are made to maximize the dispersing of scents over a large area. The larger the area the scent reaches, the greater the chances of attracting larger quantities of game. However, despite the development of many approaches to maximize scent dispersal, these approaches often have significant drawbacks.

U.S. Pat. No. 5,305,541 to Simpson on Apr. 26, 1994, U.S. Pat. No. 5,970,643 to Gawel et al. on Oct. 26, 1999, and U.S. Pat. No. 6,050,016 to Cox on Apr. 18, 2000, all teach using a fan to enlarge the area a scent can reach. All three patents show a scent dispersing device using a fan to disperse a scent that is placed inside the device itself. This approach has the drawback of residual scents remaining in the device after each usage. Hunters often need to use different scents in different situations, depending on the type of animal being hunted. A scent used to attract one type of animal may act as a deterrent for other types of animals. Therefore, a scent dispersing device must be able to effectively avoid contamination of the device from the successive use of different scents.

U.S. Pat. No. 7,040,548 to Rodgers on May 9, 2006 attempts to overcome this drawback by utilizing a special scent container to avoid contamination of the device. However, this type of device still suffers from the drawback of a scent source physically contacting a scent container that is placed within the housing, resulting in contamination of the device. A need exists, consequently, for a scent device which avoids direct contact of the scent with the device.

An important feature of effective scent dispersing devices is that the sight of and noise produced by these types of devices do not deter desired animals. U.S. Pat. No. 6,443,434 to Prather on Sep. 3, 2002 teaches a scent dispenser which operates quietly while broadcasting the scent over a wide area. The Prather device accomplishes this using a forced air dispenser for scents. However, the Prather device does not avoid the above mentioned problem of residual scents, but instead teaches to heat the scent within the housing of the device. Additionally, the Prather device does not focus on a device that facilitates ease of transport.

U.S. Pat. No. 6,592,104 to Cox on Jul. 15, 2003 teaches a scent device which is cylindrical so that it can be conveniently carried by hand. However, hunters often need use of both hands while hiking and climbing, as well as when operating hunting equipment. Therefore, a need exists that allows for the hands-free use and carrying of a scent device. Moreover, the Cox device has the above mentioned drawbacks of residual scents being deposited inside its housing. Additionally, the Cox device teaches a scent device with many specialized features which raises the production cost of the device. A need exists, then, for a device that has a relatively low manufacturing cost.

Therefore, there is a need for a scent dispersing device that, in addition to being effective at quietly dispersing a scent over a large area without causing direct contact of the scent with the device, would further allow for the hands-free use and carrying of the scent device. The needed device would further be relatively inexpensive to manufacture and assemble. The present invention accomplishes these objectives.

### SUMMARY OF THE INVENTION

The present device is an apparatus for dispersing a scent from a scent container. The device is typically used by hunters to attract animals, but may also be used by photographers and other users who wish to attract or deter animals depending on the type of scent used. The apparatus includes a housing having a front wall, a back wall, and at least one peripheral side wall, the walls defining an interior space within the housing. The back wall has at least one air inlet aperture formed therein, and the front wall has at least one air outlet aperture formed therein. In a preferred embodiment of the apparatus, the at least one peripheral wall includes a top wall, a bottom wall, and two side walls. Preferably each of the top, bottom, and side walls are substantially orthogonal to the front wall and back wall, and the front and back walls are substantially mutually parallel.

At least one wall includes a battery compartment aperture and a mechanically cooperating and removable battery compartment cover for selectively gaining access to the battery in the interior space of the housing. Preferably the battery compartment aperture and cover are formed in the back wall.

A fan is fixed within the housing and is electrically connected to a battery and a switch, the battery and the switch each being fixed within the housing. A switch actuator of the switch protrudes from a switch aperture formed in one of the walls, such that the switch actuator may be easily manually actuated. When the fan is electrically connected to the battery through the switch, the fan draws air from the air inlet aperture, through the housing, and out through the air outlet aperture. Use of a small electric fan allows for nearly noiseless operation of the apparatus, a great advantage for activities such as hunting or photographing of animals.

A container attachment means is fixed to the front wall of the housing. The container attachment means is adapted for holding the scent container on the front wall of the housing. One embodiment of the container attachment means is a resilient plastic clip projecting from the front wall of the housing, the clip cooperating with the scent container to selectively hold the container in place on the front wall of the housing. Another embodiment of the container attachment means is at least one flexible strap fixed to the front wall of the housing, wherein the at least one strap including a fastening means to selectively and adjustably hold the container in place on the front wall of the housing. The fastening means may be a hook-and-loop type fastener, for example.

As such, when the switch is electrically closed to activate the fan, the apparatus disperses the scent. The dispersion of the scent is caused by the fan blowing air across an opening of the scent container to mix air with the scent and to blow the mixture away from the housing. By blowing out across the scent container and away from the housing, contamination of the apparatus is substantially avoided.

An additional feature of the apparatus includes a wrist strap fixed to the housing. The wrist strap allows for the convenient carrying and transportation of the apparatus as well as the ability to hang the apparatus from an object, and to secure the apparatus while in use.

Additionally, an appendage attachment means may be fixed to the back wall of the housing. One embodiment of the appendage attachment means includes at least one flexible appendage strap fixed to the back wall of the housing, each of the at least one appendage straps including a hook-and-loop type fastener to selectively and adjustably hold the housing in place on a user's appendage. The appendage attachment means allows for the hands-free use and carrying of the apparatus.

The apparatus also includes an adapter power port and a power adapter, wherein the power adapter may be connected to the adapter power port to power the fan in parallel with the battery.

The present device is a scent dispersing apparatus that effectively and quietly disperses a scent over a large area without resulting in significant contact of the scent with the device. The present invention further allows for the hands-free use and carrying of the device. The present invention accomplishes these objectives and maintains a low cost of production. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a partially exploded view of the invention and a scent container, illustrating a container attachment means;

FIG. 1A is a perspective view of an alternate container attachment means;

FIG. 1B is a perspective view of another alternate container attachment means;

FIG. 2 is a front elevational view of the invention;

FIG. 3 is a rear elevational view of the invention;

FIG. 4 is a right-side perspective view of the invention, illustrating the scent container as attached thereto;

FIG. 5 is a partially cut-away rear elevational view of a battery compartment aperture and a fan;

FIG. 6 is a top plan view of the apparatus and a wrist strap; and

FIG. 7 is a left-side perspective view of the apparatus showing an adapter power port, a power adapter and an appendage attachment means.

### DETAILED DESCRIPTION OF THE PREFERRED EMBODIMENT

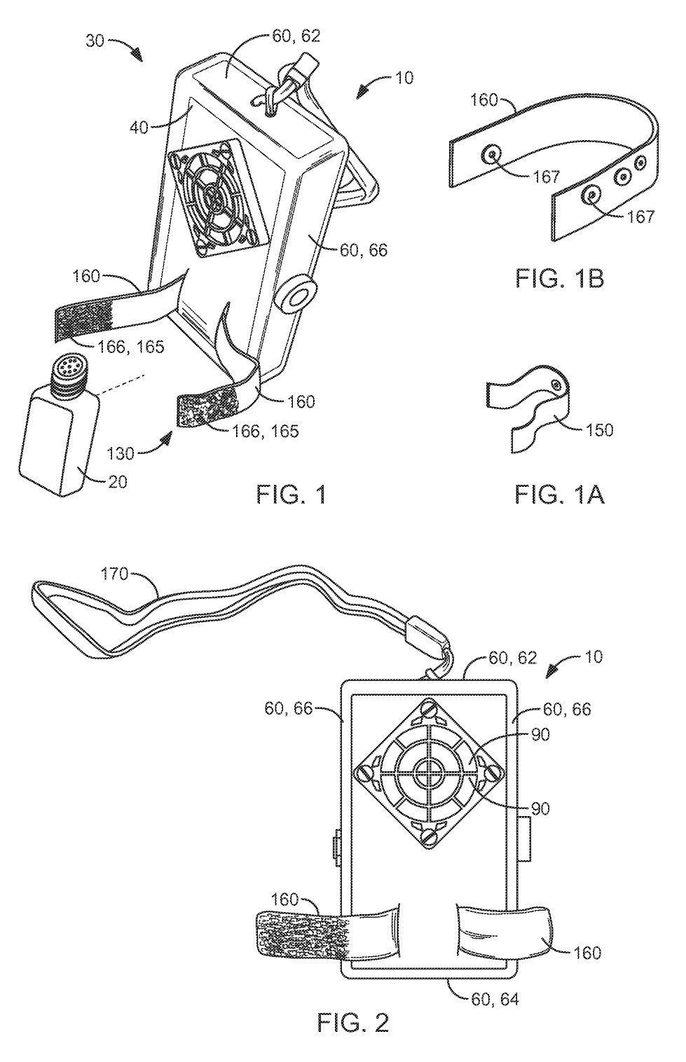

With respect to the drawings, FIG. 1 illustrates an apparatus 10 for dispersing a scent 25 from a scent container 20. The apparatus includes a housing 30 having a front wall 40, a back wall 50, and at least one peripheral side wall 60, the walls 40,50,60 defining an interior space 70 within the housing 30. The back wall 50 includes at least one air inlet aperture 80 formed therein, and the front wall 40 includes at least one air outlet aperture 90 formed therein. A preferred embodiment of the apparatus 10 has at least one peripheral wall 60 that includes a top wall 62, a bottom wall 64, and two side walls 66. Preferably, each of the top, bottom, and side walls 62,64,66 are substantially orthogonal to both the front wall 40 and the back wall 50, with the front and back walls 40,50 being substantially mutually parallel. The housing 30 is preferably made from a light weight and durable material such as a rigid plastic material, but can also be formed from any suitable rigid material, such as wood or metal, if desired. The material for the housing 30 preferably does not emit any scents and is itself resistant to absorbing other scents 25.

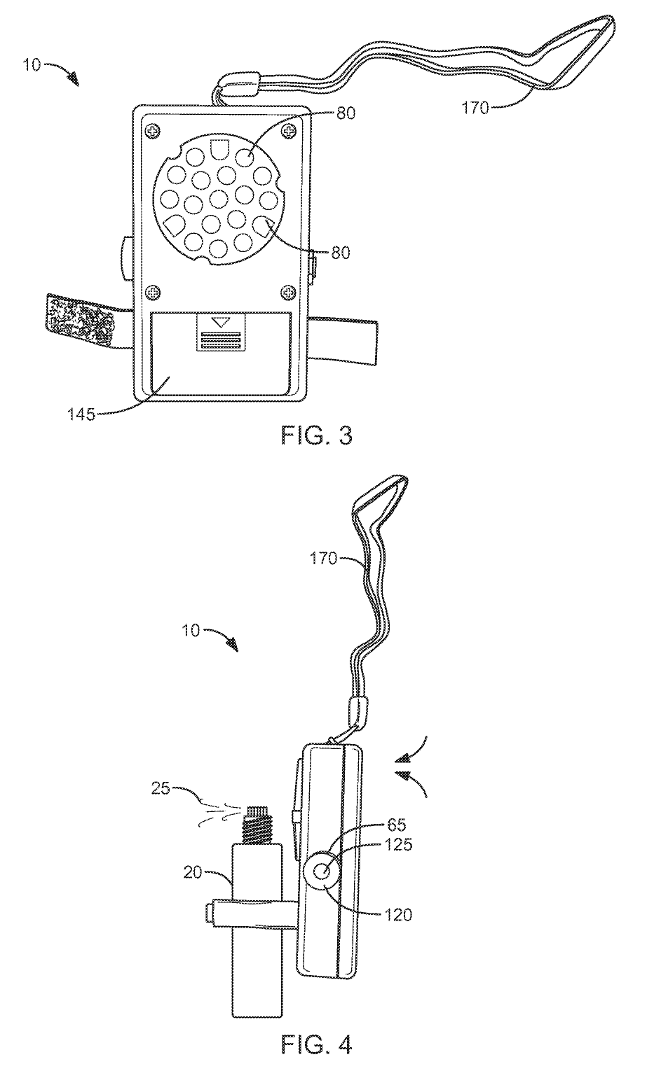

As illustrated in FIG. 3, at least one wall 40,50,60, and preferably the back wall 60, includes a battery compartment aperture 140 and a mechanically cooperating and removable battery compartment cover 145 for selectively gaining access to the battery 110 in the interior space 70 of the housing 30. Preferably a conventional 9-volt battery 110 is used for its compact size and compatibility with fans of the type used with the device.

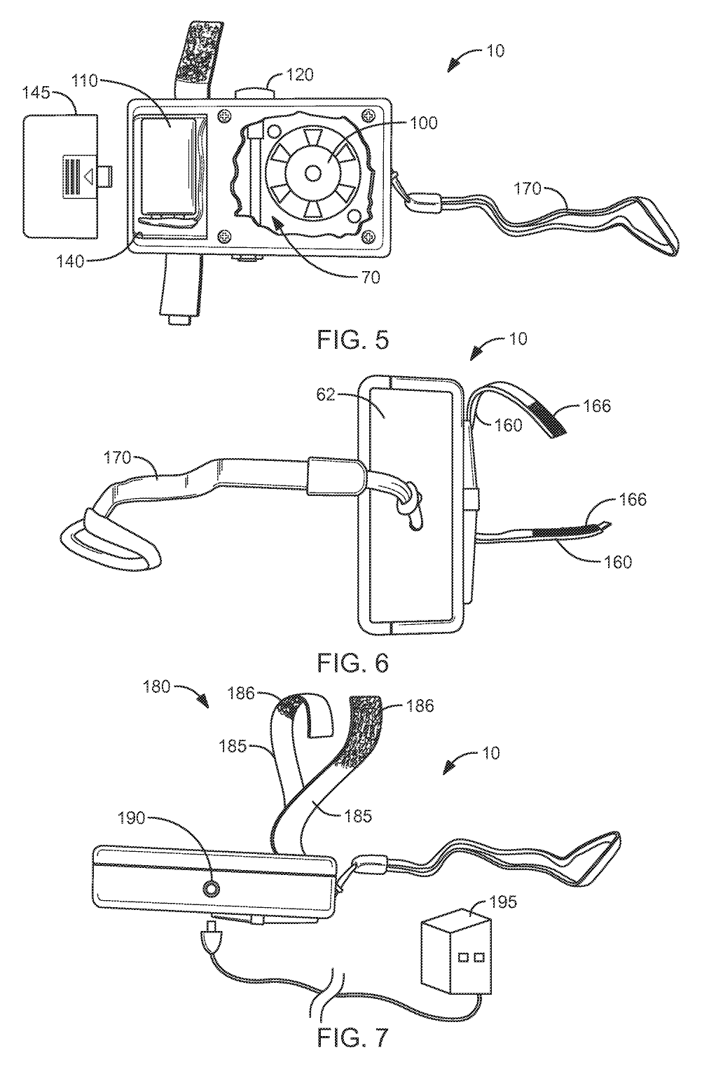

FIG. 5 illustrates a fan 100 fixed within the housing 30 and electrically connected to the battery 110 and a switch 120. The battery 110 and the switch 120 are fixed within the housing 30. A switch actuator 125 of the switch 120 protrudes from a switch aperture 65 formed in one of the walls 40,50,60, as seen in FIG. 4, so as to be conveniently manually actuated. When the fan 100 is electrically connected to the battery 110 through the switch 120, the fan 100 draws air from the air inlet aperture 80 (FIG. 3), through the housing 30, and out through the air outlet aperture 90 (FIG. 2). The fan 100 is preferably a low-voltage direct current fan 100. Such a fan 100 allows for nearly noiseless operation of the apparatus 10 and relatively long battery life, such as a day or more.

As illustrated in FIG. 1, a container attachment means 130 is fixed to the front wall 40 of the housing 30. The container attachment means 130 is adapted for holding the scent container 20 against the front wall 40 of the housing 30. One embodiment of the container attachment means 130 is a resilient plastic clip 150 (FIG. 1A) projecting away from the front wall 40 of the housing 30, the clip 150 cooperating with the scent container 20 to selectively hold the container 20 in place on the front wall 40 of the housing 30. An alternate embodiment of the container attachment means 130 is at least one flexible strap 160 fixed to the front wall 40 of the housing 30, such a strap 160 including a fastening means 165 to selectively and adjustably hold the container 20 in place on the front wall 40 of the housing 30. In the embodiment shown in FIG. 1, the fastening means 165 is a hook-and-loop type fastener 166. Another alternate embodiment of the fastening means is a mechanical snap fastener 167 shown in FIG. 1B.

The described container attachment means 130 permits the use of commercially available scent containers 20, with little concern for the shape thereof. Using commercially available scent containers 20 provides the advantage of simply buying and attaching the commercial scent container 20 of one's preferred brand of scent. This advantage avoids the additional step of transferring scent 25 from the scent container 20 to a separate scent receptacle, as with prior art devices, and keeps the scent 25 physically separate from the apparatus 10.

When the switch 120 is electrically closed, the apparatus 10 disperses a scent 25 from the scent container 20 fixed by the attachment means 130 to the front wall 40 of the housing 30. The dispersion of the scent 25 is caused by the fan 100 blowing air across an opening of the scent container 20 to mix air with the scent 25 and to blow the mixture away from the housing 30. By blowing air across the scent container 20 and away from the housing 30, scent contamination of the apparatus 10 is substantially avoided. Preventing scent contamination of the apparatus is highly desired by hunters who often need to use a variety of scents 25. The apparatus 10 allows for the successive use of different scents 25 without a previously used scent 25 leaving significant residual traces in the housing 30 of the apparatus 10 that would disadvantageously mix with subsequent uses of the apparatus 10. Furthermore, the apparatus 10 allows for the use of different scents 25 at different times without having to clean or service the apparatus 10 in-between uses, which may not be a convenient option while outdoors, for example.

FIG. 6 shows one embodiment of the apparatus 10 that includes a wrist strap 170 fixed to the housing 30. The wrist strap 170 allows for the convenient carrying and transportation of the apparatus 10 as well as the ability to suspend and secure the apparatus 10 while in use. The ability to suspend the apparatus 10 from a fixed object (not shown) allows a user to place the apparatus in a strategic place that will maximize the dispersion of the scent 25 in a given hunting area, for example.

In FIG. 7, an appendage attachment means 180 is fixed to the back wall 50 of the housing 30. The specific appendage attachment means 180 shown in FIG. 7 has at least one flexible appendage strap 185 fixed to the back wall 50 of the housing 30. Each of the at least one appendage straps 185 includes a hook-and-loop type fastener 186 to selectively and adjustably hold the housing 30 in place on a user's appendage, such as an upper arm (not shown). The appendage attachment means 180 allows for the hands-free use and carrying of the apparatus 10, a great aid to such sportsmen.

FIG. 7 also shows a version of the apparatus 10 that includes an adapter power port 190 and a power adapter 195, wherein the power adapter 195 may be connected to the adapter power port 190 to power the fan 100 in parallel with the battery 110. Such an adapter 195 may be used to recharge the battery 110, or to power the device near a structure with a power source (not shown), for example.

The overall design of the apparatus 10 makes the apparatus 10 smaller than, quieter, and more versatile than prior art devices. The light weight and compact design allows the apparatus 10 to be easily carried by hunters and other users, even during use. Furthermore, the compact design combined with incorporating only essential features minimizes the cost of production.

While a particular form of the invention has been illustrated and described, it will be apparent that various modifications can be made without departing from the spirit and scope of the invention. For example, the appendage attachment means 180 could be a mechanical snap fastener or an elastic loop (not shown). Also, the walls 40,50,60 of housing 30 could be shaped to provide a more ergonomic design. Accordingly, it is not intended that the invention be limited, except as by the appended claims.

What is claimed is:

1. An apparatus for dispersing a scent from a scent container, the apparatus comprising:
a housing having a front wall, a back wall, and at least one peripheral side wall, the walls defining an interior space within the housing, the back wall having at least one air inlet aperture formed therein, and the front wall having at least one air outlet aperture formed therein;
a fan fixed within the housing and electrically connected to a battery and a switch, the battery and the switch fixed within the housing, a switch actuator of the switch protruding from a switch aperture formed in one of the walls, the fan when electrically connected to the battery through the switch drawing air from the air inlet aperture, through the housing, and out through the air outlet aperture;
a container attachment means fixed to the front wall of the housing, the container attachment means adapted for holding the scent container on the front wall of the housing;
whereby with the scent container fixed by the attachment means to the front wall of the housing, and with the switch electrically closed, the fan blows air across an opening of the scent container to mix air with the scent and to blow the mixture away from the housing.

2. The apparatus of claim 1 wherein the at least one peripheral wall includes a top wall, a bottom wall, and two side walls, each of the top, bottom, and side walls being substantially orthogonal to the front and back walls, the front and back walls being substantially mutually parallel.

3. The apparatus of claim 1 wherein at least one wall includes a battery compartment aperture and a mechanically cooperating and removable battery compartment cover for selectively gaining access to the battery in the interior space of the housing.

4. The apparatus of claim 1 wherein the container attachment means is a resilient plastic clip projecting from the front wall of the housing, the clip cooperating with the scent container to selectively hold same in place on the front wall of the housing.

5. The apparatus of claim 1 wherein the container attachment means is at least one flexible strap fixed to the front wall of the housing, the at least one strap including a fastening means to selectively and adjustably hold same in place on the front wall of the housing.

6. The apparatus of claim 5 wherein the fastening means is a hook-and-loop type fastener.

7. The apparatus of claim 5 wherein the fastening means is a mechanical snap fastener.

8. The apparatus of claim 1 further including a wrist strap fixed to the housing.

9. The apparatus of claim 1 further including an appendage attachment means fixed to the back wall of the housing.

10. The apparatus of claim 9 wherein the appendage attachment means is at least one flexible appendage strap fixed to the back wall of the housing, each of the at least one appendage straps including a hook-and-loop type fastener to selectively and adjustably hold the housing in place on a user's appendage.

11. The apparatus of claim 1 further including an adapter power port and a power adapter, wherein the power adapter may be connected to the adapter power port to power the fan in parallel with the battery.
